(19) United States
(12) Patent Application Publication
(10) Pub. No.: US 2014/0061374 A1
(43) Pub. Date: Mar. 6, 2014

(54) METHOD FOR INCREASING LANDING GEAR EFFECTIVE LIFE AND AIRCRAFT LANDING CYCLES

(71) Applicants: Isaiah W. Cox, Baltimore, MD (US); Jan Vana, Ricany (CZ); Rodney T. Cox, North Plains, OR (US)

(72) Inventors: Isaiah W. Cox, Baltimore, MD (US); Jan Vana, Ricany (CZ); Rodney T. Cox, North Plains, OR (US)

(21) Appl. No.: 13/659,893

(22) Filed: Oct. 24, 2012

Related U.S. Application Data
(60) Provisional application No. 61/551,304, filed on Oct. 25, 2011.

(51) Int. Cl. B64C 25/40

(52) U.S. Cl. CPC B64C 25/405
USPC 244/50

(57) ABSTRACT

A method for reducing maintenance and increasing the effective life of an aircraft's landing gear, thereby increasing the aircraft's flight and landing cycles is provided. The present method eliminates adverse stresses and forces produced on landing gear components by the operation of a tow vehicle to tow the aircraft on the ground by providing an onboard wheel driver that is powered to drive at least one of the aircraft's nose wheels or main wheels to move the aircraft on the ground. Movement of the aircraft on the ground is controlled by the operation of the driver-powered drive wheel, eliminating the possibility of damage to landing gear components associated with tug operation.

### PRIORITY CLAIM

This application claims priority from U.S. Provisional Patent Application No. 61/551,304, filed 25 Oct. 2011, the disclosure of which is fully incorporated herein.

### TECHNICAL FIELD

The present invention relates generally to aircraft landing gear and aircraft landing or flight cycles and specifically to a method for increasing aircraft landing gear effective life and increasing aircraft landing or flight cycles by reducing damage and maintenance to landing gear components caused by towing aircraft on the ground.

### BACKGROUND OF THE INVENTION

An aircraft's useful service life is determined by the number of landing cycles or flight cycles the aircraft can safely experience. A landing cycle or flight cycle includes a landing, a takeoff, and the ground travel of the aircraft on the ground between landing and takeoff. Many individual aircraft structural and mechanical components, including the airframe, the engines, and the landing gear, have very specific flight cycle limits. Airframes, for example, may have a 90,000 flight cycle limit, and the safe operation of the aircraft during additional flight cycles cannot be guaranteed and may not be permitted by aviation authorities. Airlines are required to keep careful track of flight time and flight or landing cycles and to test airframes, engines, landing gear, and other components at stated intervals for signs of fatigue. This monitoring and testing is required to ensure the continued safe operation of the aircraft.

Monitoring aircraft flight or landing cycles is especially important in ensuring that the aircraft landing gear does not exceed the safe life limit calculated by the landing gear manufacturer based on fatigue tests and stress analysis. The safe life limit represents the number of landing cycles an aircraft's landing gear can experience before landing gear components will begin to show evidence of fatigue. This could include the development of fatigue cracks and other indications of component or material stress. Once a landing gear component reaches the landing cycle safe life limit, removal and scrapping of the component are required. Since replacing landing gear components can be expensive and time-consuming, the ability to extend the safe life limit of these components is highly desirable to aircraft operators.

Aircraft landing gear assemblies appear to be simple devices, but are highly complex systems capable of sustaining substantial loads that must function correctly at each landing and takeoff. In addition, aircraft landing gear may support other complex functions such as, for example, electronic nose wheel steering, weight-on-wheels switching, and anti-skid braking. Even with a very smooth landing, the sudden shock of an aircraft contacting the ground produces large forces that must be absorbed by landing gear components. Landing gear components must also be capable of functioning effectively to move the aircraft on the ground after absorbing the landing load, which requires handling other loads related to aircraft ground movement, such as those produced during taxi, braking, and turning. While stronger materials and improved hydraulic functioning in the struts have enabled the production of landing gear that function reliably and effectively to absorb and distribute these loads, even in large aircraft, today's landing gear are expensive to produce and expensive to maintain. Monitoring landing cycles and properly maintaining landing gear components according to safe life limits and mandatory inspection and/or overhaul periods is critical to the continued safe operation of both the landing gear and the aircraft on which the landing gear is mounted.

Once an aircraft's landing gear has successfully absorbed the force loads generated by contact between the landing gear component structures and the tarmac there are, as indicated above, additional loads and stresses to which the landing gear is subjected. These loads are produced as the aircraft taxis along the airport tarmac surface between landing and the aircraft's parking destination, which requires the aircraft to change direction, slow, or stop. Currently, aircraft use one or more main engines to provide the motive power for ground travel between touch down and arrival at a gate or other parking location, which can result in other stresses on landing gear components, including brakes and tires.

The operation of aircraft engines, particularly in reverse thrust, is not generally permitted in many airport ramp and gate areas. Consequently, aircraft landing gear are subjected to an additional load upon departure from a gate or other parking location prior to takeoff when an aircraft is pushed back from its parking location prior to taxi-out for takeoff by a tug or tow vehicle. Many tugs or tow vehicles attach a tow bar to the front of the aircraft to enable the tow vehicle to push the aircraft in reverse. This maneuver can produce undesirable forces on an aircraft's nose landing gear. The use of what are referred to as “towbarless” tugs or tow vehicles to move an aircraft on the ground during pushback and at other times, however, is also associated with adverse landing gear loads that can significantly limit landing gear effective life.

Towbarless tugs (also referred to as “supertugs”) use a structure, often identified as a nose wheel cradle, that captures an aircraft's nose wheels, locks the nose wheels in place on the cradle, and lifts an aircraft's nose wheel landing gear and the forward nose portion of the aircraft above the runway surface, typically by a hydraulic lifting mechanism. Towbarless tugs that function in this manner are well known. Examples of such tugs are described, for example, in U.S. Pat. No. 4,950,121 to Meyer et al and in U.S. Patent Application Publication No. US2011/0224845 to Perry et al. The entire portion of the aircraft's weight that is supported by the nose landing gear wheel assembly is applied to the tug cradle and to the tug's wheels, which greatly increases the tug's traction capability and enables the tug to move even a fully loaded aircraft.

Traction and other forces are applied to the landing gear when an aircraft is towed with a towbarless tug. Landing gear components, moreover, must absorb energy transferred between the landing gear and the tug chassis during towing. The weight of the aircraft and its fuel load can also present a major consideration during towing because the handling characteristics of the tug can change proportionally as the weight of the aircraft changes. A heavier aircraft will put more stress on the tug through the nose wheel landing gear. After the tug begins to move, a heavy aircraft, with its greater weight and momentum, will tend to push the tug with a greater force than a lighter aircraft, and this can, in turn, produce more stress on the landing gear. It has been estimated that landing gear effective life is reduced significantly, by about half, when a towbarless type of tug is used to move aircraft on the ground.

Using a towbarless tug with a nose wheel cradle to move an aircraft on the ground can present other challenges as well. Connecting and disconnecting an aircraft nose wheel to or from the tug cradle or lift structure requires trained and authorized personnel who are skilled in correctly aligning the tug with the aircraft landing gear and transferring the landing gear from the tarmac surface to the cradle without a scooping motion to minimize landing gear damage. Even an experienced tug operator may have problems steering the tug once the aircraft landing gear is in place on the tug. If oversteering occurs, the possibility of damage to the landing gear resulting from oversteering may require an immediate inspection of the landing gear that could delay takeoff of the aircraft. Additionally, a pilot or other trained and authorized person must be in the pilot's seat in the aircraft cockpit to operate the aircraft's brakes, if needed, and to communicate with the control tower and/or ramp control while the aircraft is being towed.

The use of any kind of tug to move an aircraft on the ground can increase costs for airlines and airport operators. The damage to landing gear discussed above, whether caused by a towbarless tug or a tug with a tow bar, increases landing gear maintenance costs and ultimately shortens landing gear life. Unless replacement landing gear are immediately available when landing gear are damaged, an aircraft will be out of service until damaged landing gear are repaired or replacements are on hand. Airlines incur costs and lose revenue when an aircraft is out of service and cannot fly while waiting for landing gear repairs or replacement.

Although some tugs are powered by electric power, most are powered by internal combustion engines that use fuel and produce undesirable emissions and noise. The use of tugs also increases the number of ground vehicles in congested ramp and taxiway areas, which further contributes to the undesirability of tug use. All tugs, moreover, must be checked to ensure that they are capable of safe operation prior to towing and require maintenance at regular intervals to ensure that they will be available when needed. The time required for alignment of an aircraft's landing gear and attachment to a tug and the subsequent detachment of the landing gear from the tug so the aircraft can proceed to takeoff and the tug can be returned to a ramp area must be factored into airline schedules. Additionally, tugs must be operated by skilled operators to move aircraft on the ground. Airline schedules can be delayed when an aircraft must wait for a tug or an authorized tug operator to be available. Eliminating the need for tugs to move aircraft on the ground and the landing gear damage caused by tugs could produce significant time and economic savings advantages for airlines and airport operators.

Moving an aircraft on the ground without the use of a tug or tow vehicle or the aircraft's engines has been proposed. U.S. Pat. No. 7,891,609 to Cox et al, owned in common with the present application, describes moving an aircraft along taxiways using at least one self propelled undercarriage wheel to improve turnaround time. Increasing landing gear effective life, increasing aircraft flight or landing cycles, and reducing landing gear damage during aircraft ground travel are not suggested, however.

McCoskey et al describes a powered nose aircraft wheel system useful in a method of taxiing an aircraft that can minimize the assistance needed from tugs and the aircraft engines. A precision guidance system is disclosed for controlling movement of the aircraft on the ground to minimize collision damage during taxi. Reducing landing gear damage during aircraft ground movement and increasing landing gear safe life limits or aircraft flight or landing cycles are not mentioned.

The prior art, therefore, fails to suggest a method for increasing landing gear effective life, reducing landing gear maintenance, or increasing an aircraft's landing or flight cycles that can be achieved by minimizing damage to landing gear components during aircraft ground travel.

### SUMMARY OF THE INVENTION

It is a primary object of the present invention, therefore, to overcome the deficiencies of the prior art and to provide a method for increasing aircraft landing gear effective life, reducing landing gear maintenance, and increasing an aircraft's landing or flight cycles by minimizing damage to landing gear components during aircraft ground travel.

It is an another object of the present invention to provide a method for increasing landing gear effective life and reducing landing gear maintenance that substantially eliminates forces and stresses produced during aircraft ground travel that effectively limit landing gear effective life.

It is an additional object of the present invention to provide a method for increasing aircraft flight or landing cycles and landing gear life by eliminating the damage to landing gear caused when an aircraft is towed during ground travel.

It is a further object of the present invention to provide a method for increasing aircraft landing cycles by increasing landing gear component safe life limits.

It is yet another object of the present invention to provide a method for increasing aircraft flight or landing cycles by eliminating the damage to landing gear caused when an aircraft is towed by lifting the nose wheel landing gear off the ground during ground travel.

It is yet a further object of the present invention to provide a method for reducing landing gear maintenance costs and aircraft time out of service costs due to landing gear maintenance and damage repair.

In accordance with the aforesaid objects, a method is provided for increasing aircraft flight cycles by increasing the effective life and reducing maintenance of the aircraft's landing gear. The present method eliminates adverse stresses and forces produced on landing gear when an aircraft is moved on the ground by a tow vehicle, particularly a towbarless type of tug that lifts the aircraft nose wheel landing gear off the ground, or when an aircraft is towed by any other type of tug. Landing gear effective life and landing cycles are extended and maintenance costs are reduced by providing an onboard drive assembly including an onboard wheel driver capable of translating torque through aircraft wheels and controllable to move the aircraft on the ground without any kind of tow vehicle or complete reliance on the aircraft's main engines. Movement of the aircraft on the ground is controlled solely by the operation of the onboard wheel driver, preferably in conjunction with the aircraft flight crew, thus eliminating the need for a tow vehicle or a trained operator authorized to move an aircraft with a towbarless or other kind of tug.

Other objects and advantages will be apparent from the following description, claims, and drawing.

### BRIEF DESCRIPTION OF THE DRAWINGS

FIG. 1 illustrates an aircraft being towed on the ground by a towbarless type tug; and

FIG. 2 illustrates an aircraft being moved on the ground by a self-propelled drive wheel in accordance with the method of the present invention.

### DESCRIPTION OF THE INVENTION

In today's commercial flight and airport environment, the ground travel of aircraft between landing and takeoff should ideally occur in a way that can safely, efficiently and economically move an aircraft along a potentially congested travel path with a minimum amount of fuel and without damage to aircraft components. Current practice is to use an aircraft's engines to power ground movement between touchdown and arrival and to tow aircraft at pushback until the aircraft's engines can be used for taxi prior to takeoff. Engine use adds to aircraft fuel consumption and noise as well as engine ingestion and other attendant challenges and, consequently, should be substantially eliminated or at least minimized during aircraft ground travel. In some situations, as discussed below, some minimal aircraft engine use can provide necessary electric power when an aircraft is on the ground. The present method substantially eliminates complete reliance on aircraft main engines to move an aircraft during aircraft ground travel.

Towing may be used to move aircraft not only during pushback or reverse taxi, but also at other times, such as, for example, movement of an aircraft to a hangar for maintenance. Tow vehicle use contributes to increased ground emissions, noise, and traffic congestion. As noted above, the use of tow vehicles has additionally been associated with damaging aircraft landing gear structures, increasing maintenance requirements and potentially reducing landing gear effective life by about half, thus limiting significantly the number of permitted aircraft landing or flight cycles. Reported incidents involving towbarless types of tugs have included jackknifing, uncontrolled movement and inability to stop the tug and aircraft quickly, all of which can adversely affect an aircraft's landing gear by transferring damaging forces from the tug to landing gear components. Tug tow bars apply somewhat different forces that still highly stress an aircraft's landing gear and ultimately can cause at least as much damage as towbarless tugs. Whatever the cause, this damage shortens landing gear life. The method of the present invention minimizes stress and adverse forces on landing gear structures during aircraft ground travel, which reduces maintenance requirements and effectively extends not only the useful life of landing gear components, but also extends the number of an aircraft's landing or flight cycles.

Increased maintenance may be required when aircraft are towed and/or pushed back prior to takeoff by tow vehicles. This can be seen with both towbarless tugs that lift an aircraft's nose wheel landing gear completely off the ground during towing and tugs that requirement the attachment of a tow bar. Not only does the way the landing gear is lifted off the ground by a towbarless tug so that its full weight is borne by the tug a likely contributor to damage, but the attachment operation can also jolt the airframe and the landing gear. This can subject an aircraft to stresses which it was not designed to sustain. This may, in addition, lead to long term maintenance challenges that affect the useful life of both the landing gear and the airframe and can reduce an aircraft's flight or landing cycle limit. An aircraft being towed by a tug with a tow bar is no less likely to experience landing gear damage; the damage results from forces applied in a different direction. Towing an aircraft on the ground adversely affects landing gear, and increased maintenance and shorter landing gear life are the result.

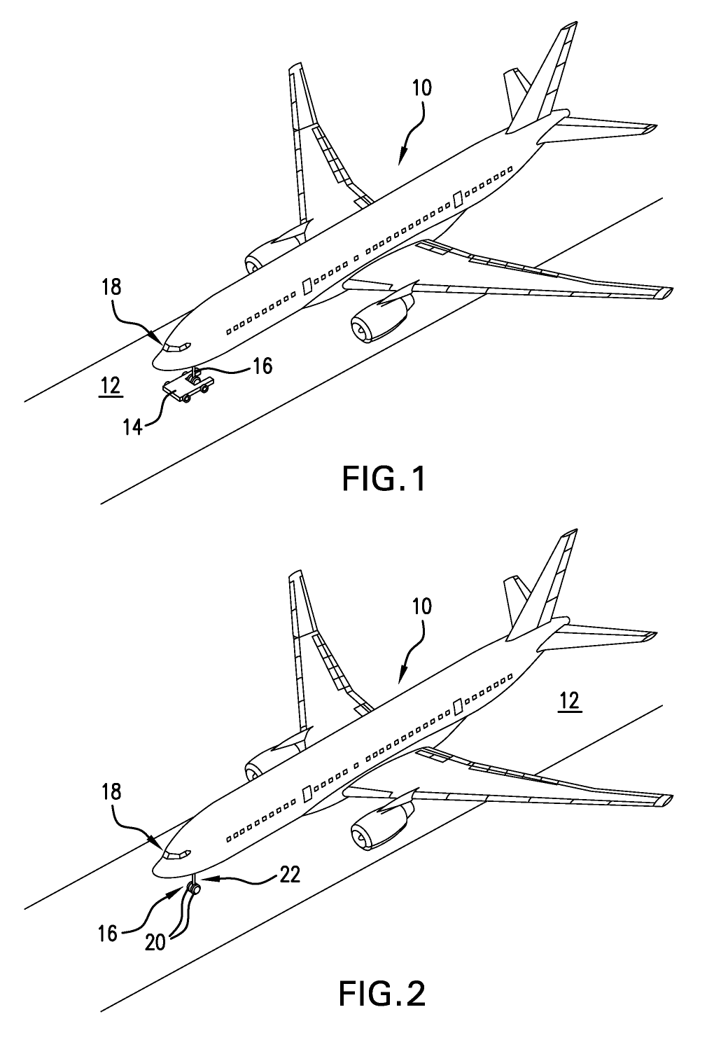

Referring to the drawings, FIG. 1 illustrates an aircraft 10 being towed along a ground surface, such as an airport runway 12, by a towbarless type of tow vehicle or tug 14. As discussed above, the aircraft's nose wheel landing gear 16 is lifted above the ground or runway surface, and the weight of this landing gear 16 and the aircraft nose portion 18 is supported only by the tug 14. The aircraft's main landing gear and wheels are not visible in FIG. 1. Although the main landing gears are not usually attached to or supported by tugs during aircraft ground movement, in some situations this may be desirable. If the main landing gears are supported by a towbarless type of tug to move an aircraft along the ground, the likelihood of main wheel landing gear damage would be similar to what can occur to nose landing gear components.

FIG. 2 illustrates an aircraft 10 moving along a runway 12 so that stress on the nose wheel landing gear 16 and damage to the landing gear is minimized and loads on the landing gear produced by the tug 14 of FIG. 1 are eliminated in accordance with the present invention. As in FIG. 1, the main landing gear and wheels are not visible in FIG. 2. The nose wheel landing gear includes one or more wheels 20. Two nose wheels 20 are shown in FIG. 1. One or more of the nose wheels 20 is designed to be powered by one or more onboard drivers 22 associated with one or more of the nose wheels so that the powered wheel or wheels can drive the aircraft along the ground without relying entirely on the aircraft's engines providing direct thrust or requiring a tow vehicle or tug. Although the driver 22 is shown associated with the aircraft's nose wheels 20, the driver could also power one or more of the aircraft's main wheels (not shown). Additionally, while a preferred location for the one or more driver may be in or near a wheel, the driver could also be positioned in other locations in or on the aircraft as discussed below.

A powered aircraft drive wheel 22, which can be a powered nose drive wheel as shown or a powered aircraft main drive wheel, is uniquely positioned to maneuver an aircraft in a variety of circumstances on the ground without assistance from the aircraft's engines or external tow vehicles or tugs. The terms “drive wheels” and “self-propelled drive wheels,” as used herein, refer to any aircraft wheels that are connected to and powered or driven by an onboard driver as described below. An onboard driver for a powered drive wheel optimally exerts sufficient power to propel or move the aircraft at runway speeds, and its preferred small size enables the driver to fit within a nose wheel or main wheel landing gear space or in any other convenient onboard location inside or outside the wheel, without limitation. An aircraft with a powered self-propelled nose wheel or other aircraft drive wheel, such as a main wheel, will have one or more wheel drivers mounted in driving relationship with one or more of the aircraft wheels to move the wheels at a desired speed and torque.

The method for increasing landing gear effective life and increasing aircraft flight and landing cycles of the present invention allows the aircraft's engines to be turned off very shortly after landing and to remain off until shortly before takeoff. Substantially eliminating reliance on the use of the aircraft engines during taxi also reduces aircraft fuel consumption and eliminates the jet blast, engine ingestion, noise, and air pollution associated with operation of an aircraft's engines on the ground. Even if an aircraft engine is required to provide electric power as discussed below, the engine can be set to provide no thrust. Tugs are also not required to move aircraft. Consequently, a safer, quieter, and less congested runway and ramp environment is possible.

Ground movement of the aircraft is produced instead by the operation of one or more onboard drivers drivingly associated with one or more of the aircraft wheels. The driver or drivers are ideally powered independently of the aircraft's engines to cause one or more of the aircraft's wheels to rotate at a desired speed, or at a torque associated with a desired speed, while the aircraft is on the ground, thus providing the power to move the aircraft at the desired speed. However, generators on the aircraft engines may be used to power electric driver assemblies and bleed air may be used to power pneumatic driver assemblies. While, as indicated, a preferred location for a driver is adjacent to or within an aircraft wheel, driver locations are not limited. A driver can be positioned at any location where it can be connected with one or more aircraft wheels to provide the driving power required to move the aircraft wheel or wheels at a desired speed or torque and, hence, the aircraft at a desired speed on the ground. Possible locations for one or more drivers in addition to those within or adjacent to a wheel include, without limitation, on or near the wheel axle, in, on or near a landing gear bay or landing gear component, or any convenient onboard location in, on, or attached to the aircraft.

The term driver, as used herein in a preferred embodiment, refers to any onboard driver, whether or not located in a wheel, capable of moving an aircraft on the ground. Drivers preferred for use with the method of the present invention could be hydraulic, pneumatic, electric, or any other type of driver that can transfer force through an aircraft wheel. The aircraft's auxiliary power unit (APU) is the preferred source of electric power for powering drivers that require electric power. In the event, however, that the APU is inoperative or otherwise unavailable for supplying electric power, one or more of the aircraft's main engines can be used as a back-up power source. One or more of an aircraft's main engines could additionally be employed as a source of bleed air for a drive wheel with a pneumatic driver. While the aircraft engines do not supply power nearly as efficiently as the APU, they do provide an available alternative. Should it be necessary to rely on one or more engines to supply power or bleed air, the thrust levels can be set so that the engine or engines are providing only electric or pneumatic power to power the drive wheel to move the aircraft and are not providing thrust. Using the aircraft's main engines to power a drive wheel under these circumstances may result in a loss of economic and other benefits and advantages of not using the aircraft engines during ground travel. Such engine use may be justified, in the event of an APU failure for example, to obtain at least some of the benefits of powered self-propelled aircraft ground movement.

One particularly preferred driver is an electric driver that is preferably an enclosed machine capable of operating for at least several minutes at maximum torque and for over 20 minutes at cruise torque. This electric driver could be any one of a number of designs, for example an inside-out motor attached to a wheel hub in which the rotor can be internal to or external to the stator, such as that shown and described in U.S. Patent Application Publication No. 2006/0273686, the disclosure of which is incorporated herein by reference. A toroidally-wound motor, an axial flux motor, a permanent magnet brushless motor, a synchronous motor, an asynchronous motor, a pancake motor, a switched reluctance motor, electric induction motor, or any other electric motor geometry or type known in the art is also contemplated to be suitable for use in the present invention.

The driver selected, whether hydraulic, pneumatic, electric, or any other type of driver, should be able to move an aircraft wheel at a desired speed and torque. One kind of electric drive motor preferred for this purpose is a high phase order electric motor of the kind described in, for example, U.S. Pat. Nos. 6,657,334; 6,838,791; 7,116,019; and 7,469,858, all of which are owned in common with the present invention. A geared motor, such as that shown and described in U.S. Pat. No. 7,469,858, is designed to produce the torque required to move a commercial sized aircraft at an optimum speed for ground movement. The disclosures of the aforementioned patents are incorporated herein by reference. As indicated above, any form of driver or motor capable of driving a landing gear wheel to move an aircraft on the ground may also be used. Other motor designs capable of high torque operation across a desired speed range that can move an aircraft wheel to function as described herein may also be suitable for use in the present invention. A particularly preferred driver motor is a high phase order induction motor with a top tangential speed of about 15,000 linear feet per minute and a maximum rotor speed of about 7200 rpm. With an effective wheel diameter of about 27 inches and an appropriate gear ratio, an optimum top speed of about 28 miles per hour (mph) can be achieved, although any speed appropriate for aircraft ground travel in a particular runway environment could be achieved and is contemplated to be within the scope of the present invention.

A wheel driver capable of reducing landing gear maintenance and extending landing gear life and aircraft flight cycles in accordance with the present invention is specifically designed to be retrofitted on existing aircraft without requiring changes to existing wheel structures, including the brakes, to produce self-propelled drive wheels. A major advantage of the design of this preferred wheel driver is achieved by the continued use of the existing tires, axle, and piston already in use on an aircraft. Since these structures are not altered from their original condition or otherwise changed in any way by the installation of the present wheel driver assembly, the rim width, tire bead, and bead seat would not require re-certification by the FAA or other authorities, thus eliminating a potentially time consuming and costly process. As a result, the wheel driver described herein is especially well suited for installation on existing aircraft to increase landing gear effective life and increase aircraft flight cycles. Additionally, the controls required to operate a wheel driver as described herein can be also retrofitted conveniently within the existing cockpit controls.

Moving an aircraft on the ground using a wheel driver as described above requires providing sufficient power to the driver to produce a torque capable of driving an aircraft wheel to move the aircraft at a desired ground speed. When an electric driver is used in the present method, the current, and the voltage and frequency of the current, applied to the motor can be controlled to regulate speed. In an aircraft wheel drive assembly useful in the present invention, current to power the motor preferably originates with the aircraft auxiliary power unit (APU). Other power sources could also be used to supplement or replace the APU as a source of power. These power source can include, for example without limitation, batteries, fuel cells, any kind of solar power, POWER CHIPS®, and burn boxes, as well as any other suitable power source for this purpose. The capability for controlling the flow of current to the driver, as well as voltage and frequency of the current, allows the torque generated by the driver to be controlled and, therefore, control of the speed of the wheel powered by the driver and the ground travel speed of the aircraft. In the event the APU or one of the aforementioned power sources is not available, as noted above, electric power may be generated by one or more of the aircraft's engines to power the aircraft wheel drive and keep the aircraft moving on the ground.

A motor control system suitable for controlling an onboard electric driver is described in commonly owned U.S Patent Publication No. US2008/0147252 to Bayer, the disclosure of which is incorporated herein by reference. The control system described by Bayer includes software that uses a closed loop control in conjunction with other control laws to operate one or more electric motors of the type described above to move an aircraft during taxi. Extending landing gear life and/or aircraft flight cycles is not part of this control system, however.

As described above in the Background of the Invention section, adverse stresses and forces on an aircraft's landing gear caused by positioning and securing the landing gear to a tow bar or on a towbarless tug lift cradle that damage landing gear are eliminated when the aircraft is driven on the ground by powered drivers. Since aircraft are self-propelled on the ground at all times by one or more wheel drivers, the possibility of additional damage to landing gear resulting from the towing of aircraft by tugs is also eliminated. With the elimination of major causes of the reduction in landing gear maintenance and effective life, the number of aircraft flight and landing cycles can be increased. An aircraft's landing or flight cycle, which includes a landing and a takeoff and the ground movement of an aircraft in between these events, will no longer be required to take into account the reduction of landing gear safe life limits produced by damage resulting from attachment and towing of an aircraft by a tug. Consequently, the number of landing or flight cycles possible within landing gear safe life limits can be increased by the implementation of the present method. In addition, landing gear maintenance demands and costs will be significantly reduced, as will aircraft time out of service from tug-related landing gear damage and repairs.

While the present invention has been described with respect to preferred embodiments, this is not intended to be limiting, and other arrangements and structures that perform the required functions are contemplated to be within the scope of the present invention.

### INDUSTRIAL APPLICABILITY

The present invention will find its primary applicability where it is desired to reduce landing gear maintenance costs and to extend aircraft landing gear safe limits and useful life and to increase an aircraft's or a fleet of aircrafts' number of possible flight and landing cycles. The economic advantages possible with the present method will be attractive to airlines and airport operators.

1. A method comprising reducing damage to aircraft landing gear caused by external tow vehicles comprising providing onboard wheel drive means capable of translating torque through aircraft wheels and controllable to move the aircraft on the ground without said tow vehicles.

2. The method of claim 1, wherein the aircraft is moved on the ground by onboard wheel drive means comprising any motor capable of producing the torque required to move a commercial sized aircraft at an optimum speed for ground movement.

3. The method of claim 2, wherein the onboard wheel drive means is selected from the group consisting of electric induction motors, permanent magnet brushless DC motors, switched reluctance motors, hydraulic pump/motor assemblies, and pneumatic motors.

4. The method of claim 1, wherein the onboard wheel drive means is mounted on at least one aircraft nose wheel or on at least one aircraft main wheel.

5. The method of claim 1, wherein said onboard wheel drive means is powered by a power source selected from the group consisting of an aircraft's auxiliary power unit, an aircraft's main engines, batteries, fuel cells, solar power, POWER CHIPS®, and burn boxes.

6. The method described in claim 3, wherein said onboard wheel drive means comprises an electric motor capable of driving an aircraft on the ground selected from the group comprising high phase order electric motors, electric induction motors, permanent magnet brushless DC motors, and switched reluctance motors.

7. The method described in claim 1, wherein said onboard wheel drive means is located at a selected location inside an aircraft nose or main wheel, at a selected location adjacent to an aircraft nose or main wheel, at a selected location within the aircraft, or at a selected location attached to the aircraft airframe.

8. A method comprising substantially reducing stresses on and damage to an aircraft's landing gear comprising providing an onboard drive assembly mounted to drive at least one of the aircraft's wheels and controllable to move the aircraft on the ground by transmitting force through the wheels.

9. A method comprising extending aircraft landing gear useful life comprising providing an onboard drive assembly mounted to drive at least one of the aircraft's wheels and controllable to move the aircraft on the ground by transmitting force through the wheels.

10. A method comprising extending time intervals between maintenance requirements and reducing extent of maintenance required for an aircraft's landing gear comprising providing an onboard drive assembly mounted to drive at least one of the aircraft's wheels and controllable to move the aircraft on the ground by transmitting force through the wheels.

11. A method comprising simultaneously substantially reducing stresses on and damage to an aircraft's landing gear and extending landing gear useful life and time between landing gear maintenance and the extent of said maintenance comprising providing an onboard drive assembly mounted on at least one of the aircraft's wheels and controllable to move the aircraft on the ground by transmitting force through the wheels.

12. The method of claim 11, wherein the onboard drive assembly is any motor capable of producing the torque required to move a commercial sized aircraft at an optimum speed for ground movement.

13. The method of claim 12, wherein the onboard drive assembly comprises an electric motor selected from the group consisting of electric induction motors, permanent magnet brushless DC motors, and switched reluctance motors.

14. The method of claim 11, wherein the onboard drive assembly is mounted on at least one of the aircraft's nose wheels or on at least one main wheel drive of said aircraft.

15. The method of claim 11, wherein said at least one aircraft wheel is powered by a power source selected form the group including the aircraft's auxiliary power unit, the aircraft's main engines, batteries, fuel cells, any kind of solar power, POWER CHIPS®, and burn boxes.

16. A method comprising substantially eliminating stresses on and damage to the nose landing gear of an aircraft caused by the use of an external tow vehicle comprising providing an onboard driver mounted to drive at least one of the aircraft's nose wheels and powered by a power source other than the aircraft main engines.

17. A method comprising increasing aircraft flight cycles comprising increasing effective life of landing gear of said aircraft by retrofitting said aircraft with at least one wheel driver powered to drive the aircraft during taxi on the ground independently of the aircraft engines or an external tow vehicle.

18. A method comprising simultaneously reducing damage to aircraft landing gear caused by external tow vehicles, reducing stresses on and damage to an aircraft's landing gear, extending aircraft landing gear useful life, extending time intervals between maintenance requirements, and reducing extent of maintenance required for an aircraft's landing gear comprising providing one or more onboard drive assemblies mounted to drive at least one of the aircraft's nose or main wheels and controllable to move the aircraft on the ground, wherein said one or more drive assemblies comprise an electric, pneumatic, or hydraulic motor capable of producing the torque required to move a commercial sized aircraft at an optimum speed for ground movement and controlling said one or more drive assemblies to move said aircraft during ground movement without assistance from tow vehicles or operation of aircraft engines.
